(19) United States
(12) Patent Application Publication
(10) Pub. No.: US 2021/0133468 A1
(43) Pub. Date: May 6, 2021

(54) Action Recognition Method, Electronic Device, and Storage Medium

(71) Applicant: Beijing Sensetime Technology Development Co., Ltd., Beijing (CN)

(72) Inventors: Yanjie Chen, Beijing (CN); Fei Wang, Beijing (CN); Chen Qian, Beijing (CN)

(73) Assignee: Beijing Sensetime Technology Development Co., Ltd., Beijing (CN)

(21) Appl. No.: 17/144,989

(22) Filed: Jan. 8, 2021

Related U.S. Application Data
(63) Continuation of application No. PCT/CN2019/092715, filed on Jun. 25, 2019.

(30) Foreign Application Priority Data
Sep. 27, 2018 (CN) 201811132681.1

(51) Int. Cl. G06K 9/00; G06N 3/08

(52) U.S. Cl. CPC G06K 9/00845; G06N 3/08; G06K 9/00268; G06K 9/00248

(57) ABSTRACT

The present disclosure relates to an action recognition method, an electronic device, and storage medium. The action recognition method includes: detecting a target part on a face in a detection image; capturing a target image corresponding to the target part from the detection image according to the detection result for the target part; and recognizing, according to the target image, whether the object having the face executes a set action. Embodiments of the present disclosure are applicable to faces of different sizes in different detection images, and are also applicable to faces of different types. The embodiments of the present disclosure have a wide application range. Not only the target images may include sufficient information for analysis, but also the problems of low system processing efficiency caused by oversized captured target images and excessive useless information are reduced.

### CROSS-REFERENCE TO RELATED APPLICATIONS

The present application is a continuation of and claims priority under 35 U.S.C. 120 to PCT Application. No. PCT/CN2019/092715, filed on Jun. 25, 2019, which claims priority to Chinese Patent Application No. 201811132681.1, filed with the Chinese Patent Office on Sep. 27, 2018 and entitled “ACTION RECOGNITION METHOD AND APPARATUS, AND DRIVER STATE ANALYSIS METHOD AND APPARATUS”. All above-referenced priority documents are incorporated herein by reference in their entireties.

### TECHNICAL FIELD

The present disclosure relates to the technical field of image processing, and particularly to an action recognition method and apparatus, and a driver state analysis method and apparatus.

### BACKGROUND

Action recognition is widely applied in the field of safety, and properties such as accuracy and efficiency of the action recognition are matters of concern in the application fields.

### SUMMARY

The present disclosure provides technical solutions of action recognition.

According to one aspect of the present disclosure, provided is an action recognition method, including: detecting a target part on a face in a detection image; capturing a target image corresponding to the target part from the detection image according to the detection result for the target part; and recognizing, according to the target image, whether the object having the face executes a set action.

According to one aspect of the present disclosure, provided is a driver state analysis method, including: obtaining a detection image of a driver; recognizing, using the action recognition method above, whether the driver executes a set action; and determining a state of the driver according to the recognized action.

According to one aspect of the present disclosure, provided is an action recognition apparatus, including: a target part detection module, configured to detect a target part on a face in a detection image; a target image capturing module, configured to capture a target image corresponding to the target part from the detection image according to the detection result for the target part; and an action recognition module, configured to recognize, according to the target image, whether the object having the face executes a set action.

According to one aspect of the present disclosure, provided is a driver state analysis apparatus, including: a driver image obtaining module, configured to obtain a detection image of a driver; an action recognition module, configured to recognize, using the action recognition apparatus above, whether the driver executes a set action; and a state recognition module, configured to determine a state of the driver according to the recognized action.

According to one aspect of the present disclosure, provided is an electronic device, including: a processor; and a memory configured to store processor-executable instructions, where the processor is configured to: execute the action recognition method and/or the driver state analysis method above.

According to one aspect of the present disclosure, provided is a computer readable storage medium, having computer program instructions thereon, where when the computer program instructions are executed by a processor, the action recognition method and/or the driver state analysis method above are implemented.

According to one aspect of the present disclosure, provided is a computer program, including a computer readable code, where when the computer readable code runs in an electronic device, a processor in the electronic device executes the action recognition method and/or the driver state analysis method.

In embodiments of the present disclosure, a target part on a face is recognized in a detection image, a target image corresponding to the target part is captured from the detection image according to the detection result for the target part, and according to the target image, whether the object having the face executes a set action is recognized. The target images captured according to the detection result for the target part are applicable to faces of different sizes in different detection images, and are also applicable to faces of different types. The embodiments of the present disclosure have a wide application range. Not only the target images may include sufficient information for analysis, but also the problems of low system processing efficiency caused by oversized captured target images and excessive useless information are reduced

The other features and aspects of the present disclosure can be described more clearly according to the detailed descriptions of the exemplary embodiments in the accompanying drawings below.

### BRIEF DESCRIPTION OF THE DRAWINGS

The accompanying drawings included in the specification and constituting a part of the specification illustrate the exemplary embodiments, features, and aspects of the present disclosure together with the specification, and are used for explaining the principles of the present disclosure.

FIG. 1 is a flowchart illustrating an action recognition method according to embodiments of the present disclosure;

FIG. 2 is a flowchart illustrating an action recognition method according to embodiments of the present disclosure;

FIG. 3 is a flowchart illustrating an action recognition method according to embodiments of the present disclosure;

FIG. 4 is a flowchart illustrating an action recognition method according to embodiments of the present disclosure;

FIG. 5 is a flowchart illustrating an action recognition method according to embodiments of the present disclosure;

FIG. 6 is a flowchart illustrating a driver state analysis method according to embodiments of the present disclosure;

FIG. 7 is a detection image in an action recognition method according to embodiments of the present disclosure;

FIG. 8 is a schematic diagram illustrating a face detection result in an action recognition method according to embodiments of the present disclosure;

FIG. 9 is a schematic diagram illustrating determining a target image in an action recognition method according to embodiments of the present disclosure;

FIG. 10 is a schematic diagram illustrating performing action recognition in an action recognition method according to embodiments of the present disclosure;

FIG. 11 is a schematic diagram illustrating introducing a noise image to train a neural network in an action recognition method according to embodiments of the present disclosure;

FIG. 12 is a block diagram illustrating an action recognition apparatus according to embodiments of the present disclosure;

FIG. 13 is a block diagram illustrating a driver state analysis apparatus according to embodiments of the present disclosure;

FIG. 14 is a block diagram illustrating an action recognition apparatus according to exemplary embodiments;

FIG. 15 is a block diagram illustrating an action recognition apparatus according to exemplary embodiments.

### DETAILED DESCRIPTION

Various exemplary embodiments, features, and aspects of the present disclosure are described below in detail with reference to the accompanying drawings. The same reference numerals in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

In addition, numerous details are given in the following detailed description for the purpose of better explaining the present disclosure. It should be understood by persons skilled in the art that the present disclosure may still be implemented even without some of those details. In some examples, methods, means, elements, and circuits that are well known to persons skilled in the art are not described in detail so that the principle of the present disclosure becomes apparent.

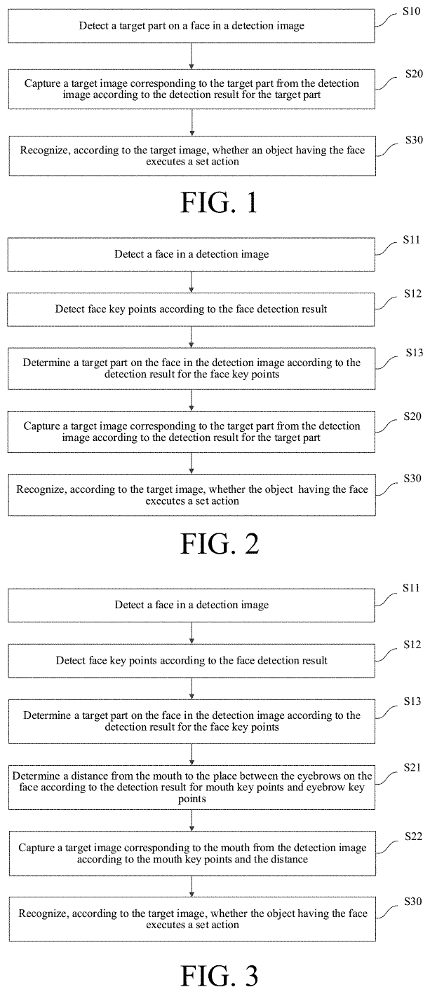

FIG. 1 is a flowchart illustrating an action recognition method according to embodiments of the present disclosure. The action recognition method can be executed by electronic devices such as terminal devices or servers, where the terminal devices may be a User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementations, the action recognition method may be implemented by invoking, by a processor, computer readable instructions stored in a memory.

As shown in FIG. 1, the action recognition method includes the following steps.

At step S10, a target part on a face is detected in a detection image.

In a possible implementation, the detection image may include a single image, or may also include an image frame in a video stream. The detection image may include an image directly obtained by a photographing device through photographing, or may also include an image obtained by performing preprocessing such as denoising on the image obtained by the photographing device through photographing. The detection image may include multiple types of images such as a visible light image, an infrared image, a near-infrared image. No limitation is made thereto in the present disclosure.

In a possible implementation, the detection image may be acquired by means of a camera, the camera including at least one of: a visible light camera, an infrared camera, or a near-infrared camera. The visible light camera is configured to acquire a visible light image, the infrared camera is configured to acquire an infrared image, and the near-infrared camera is configured to acquire a near-infrared image.

In a possible implementation, a face-based action is generally related with the five sense organs on the face. For example, an action of smoking or eating is related with the mouth, and an action of making a call is related with the ear. The target part on the face may include one or any combination of the following parts: mouth, ear, nose, eye, and eyebrow. The target part on the face is determined according to needs. The target part on the face may include one or more parts, and is detected by means of the face detection technology.

At step S20, a target image corresponding to the target part is captured from the detection image according to the detection result for the target part.

In a possible implementation, the face-based action is centered on the target part, and the region outside the face in the detection image may include an object related with the action. For example, the action of smoking is centered on the mouth, and smoke may appear in the region outside the face in the detection image.

In a possible implementation, the area occupied by the face in the detection image is different, the position of the face is different, and the face is also different in length and fatness. The area of a target image captured by using a capture bounding box with a set size may be too small, the target image may not be able to include sufficient information, and thus the action detection result is inaccurate. The area of the captured target image may also be too large, and the target image includes excessive useless information, resulting in low analysis efficiency.

For example, in the detection image, the area occupied by the face of person A is small, and the area occupied by the face of person B is large. If a bounding box with a set area is used for capturing the target image from the detection image, a target image with a sufficient area of the mouth of person A is captured, but a target image with a sufficient area of the mouth of person B cannot be captured, resulting in that an accurate action detection result cannot be obtained according to the target image of the mouth of person B; or a target image with a sufficient area of the mouth of person B is captured, but the area of the target image of the mouth of person A is large, resulting in that the target image of the mouth of person A includes excessive useless information, and the system processing efficiency is reduced.

In a possible implementation, the position of the target part on the face is determined according to the detection result for the target part, and the capturing size and/or the capturing position of the target image are determined according to the position of the target part on the face. According to the embodiments of the present disclosure, the target image corresponding to the target part is captured in the detection image according to a set condition, so that the captured target image is more in line with face features of the object having the face. For example, the size of the captured target image is determined according to a distance between the target part and a set position on the face. For example, the size of the target image of the mouth of person A is determined according to a distance between the mouth of person A and the center point of the face of person A, and the size of the target image of the mouth of person B is also determined according to a distance between the mouth of person B and the center point of the face of person B. As the distance between the mouth and the center of the face is related with features of the face, the captured target image is more in line with the features of the face. The target image captured according to the position of the target part on the face is more in line with the features of the face, and also includes a more complete image region having an object related with the action.

At step S30, according to the target image, whether the object having the face executes a set action is recognized.

In a possible implementation, a feature of the target image is extracted, and whether the object having the face executes the set action is determined according to the extracted feature.

In a possible implementation, the set action may include one or any combination of the following actions: smoking, eating, wearing a mask, drinking water/a beverage, making a call, and doing makeup. When the object having the face executes the set action, the target may simultaneously conduct an action such as driving, walking, and riding, and the set action may distract the attention of the object having the face, causing safety hazards. According to the recognition result of the set action, applications such as safety analysis are carried out on the object having the face. For example, if the detection image is an image obtained by a monitoring camera through photographing on the road, the face in the detection image is the face of a driver who drives a vehicle. If it is detected that the object having the face in the detection image is conducting a smoking action, whether the object having the face is smoking is determined by extracting the feature in the target image of the mouth and determining according to the feature whether the target image includes a smoke feature, and if the driver is conducting the smoking action, it is considered that there is a safety hazard.

In the present embodiment, a target part on a face is recognized in a detection image, a target image corresponding to the target part is captured from the detection image according to the detection result for the target part, and according to the target image, whether the object having the face executes a set action is recognized. The target images captured according to the detection result for the target part are applicable to faces of different sizes in different detection images, and are also applicable to faces of different types. The embodiments of the present disclosure have a wide application range. Not only the target images may include sufficient information for analysis, but also the problems of low system processing efficiency caused by oversized captured target images and excessive useless information are reduced

FIG. 2 is a flowchart illustrating an action recognition method according to embodiments of the present disclosure. As shown in FIG. 2, step S10 in the action recognition method includes the following steps.

At step S11, the face in the detection image is detected.

In a possible implementation, the face in the detection image is detected by using a face detection algorithm. The face detection algorithm may include: 1. extracting a feature in the detection image; 2. determining candidate bounding boxes in the detection image according to the extracted feature; 3. determining a face bounding box in the candidate bounding boxes according to a classification result of the multiple candidate bounding boxes; and 4. using coordinate fitting to obtain coordinates of the face bounding box in the detection image, so as to obtain a face detection result. The face detection result may include coordinates of four vertices of the face bounding box, and the length and width of the face bounding box.

At step S12, face key points are detected according to the face detection result.

In a possible implementation, the face key points may include points at sets position on the face, or points at different positions on each part of the face may be determined as the face key points. For example, the face key points may include points on the contour line of an eye (the outer corner of the eye, the inner corner of the eye, etc.), points on the contour line of an eyebrow, points on the contour line of the nose, and the like. The positions and quantity of the face key points are determined according to needs. The feature of the region where the face bounding box is located in the detection image is extracted, and by using a set mapping function and the extracted feature, the two-dimensional coordinates of the key points on the face in the detection image are obtained.

At step S13, the target part on the face in the detection image is determined according to the detection result for the face key points.

In a possible implementation, the target part on the face is accurately determined according to the face key points. For example, the eye can be determined according to the face key points related with the eye, and the mount can be determined according to the face key points related with the mouth.

In a possible implementation, the target part includes the mouth, and the face key points includes mouth key points, and step S13 includes:

determining the mouth on the face in the detection image according to a detection result for the mouth key points.

In a possible implementation, the face key points may include mouth key points, ear key points, nose key points, eye key points, eyebrow key points, face outer contour key points, and the like. The mouth key points may include one or more key points on an upper lip contour line and a lower lip contour line. The mouth on the face in the detection image is determined according to the mouth key points.

In the present embodiment, a face is detected in the detection image, face key points are then detected, and a target part is determined according to the face key points. The target part determined according to the face key points is more accurate.

FIG. 3 is a flowchart illustrating an action recognition method according to embodiments of the present disclosure. The target part includes the mouth, the face key points include the mouth key points and the eyebrow key points, and as shown in FIG. 3, step S20 in the action recognition method includes the following steps.

At step S21, a distance from the mouth to the place between the eyebrows on the face in the detection image is determined according to the detection result for the mouth key points and the eyebrow key points.

At step S22, the target image corresponding to the mouth is captured from the detection image according to the mouth key points and the distance.

In a possible implementation, the eyebrow key points may include one or more key points on left and right eyebrow contour lines. The eyebrows on the face are determined according to the eyebrow key points, and the position of the place between the eyebrows on the face is determined.

In a possible implementation, faces in different detection images may occupy different areas, and the types of different faces may also be different. The distance between the mouth and the place between the eyebrows directly and comprehensively reflects the area occupied by the face in the detection image, and also directly and comprehensively reflects the difference in the type of the face. By capturing a target image corresponding to a mouth according to a distance between the mouth and the place between eyebrows on the face, the image contents included in the target images are different as the personal features of the faces are different. Regions outside the face and below the mouth are also included, so that an object related with a mouth action is also included in the target image. On the basis of the feature of the target image, recognition for precise actions occurring at the mouth or around the mouth, for example, smoking or making a call, is facilitated.

For example, if the face is relatively long, the distance from the mouth to the place between the eyebrows is relatively long, the area of the target image determined according to the mouth key points and the distance between the mouth and the place between the eyebrows is relatively large, and the target image is more in line with the features of the face. Smoke related with the action of smoking may also be included in the target image and within a region outside the face, making the action recognition result for smoking become more accurate.

In a possible implementation, the target image may be of any shape. For example, the distance from the mouth to the place between the eyebrows on the face is set as d, and taking the center point of the mouth as the center, and a length longer than d as a side length, a rectangular target image is captured. In the captured target image, a region outside the face and below the mouth is included. During detection for an action with the mouth as the target part, objects such as smoke and food may be detected in the region outside the face and below the mouth, making the action detection result become more accurate.

In the present embodiment, the target image of the mouth captured according to the distance from the mouth to the place between the eyebrows on the face is more in line with the features of the face, and may include a region outside the face and below the mouth, making the result of action detection taking the mouth as the target part become more accurate.

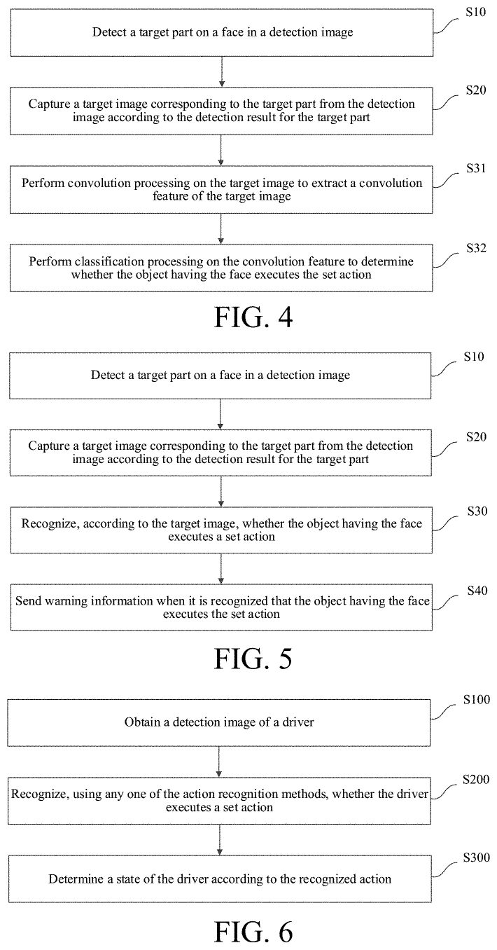

FIG. 4 is a flowchart illustrating an action recognition method according to embodiments of the present disclosure. As shown in FIG. 4, step S30 in the action recognition method includes the following steps.

At step S31, convolution processing is performed on the target image to extract a convolution feature of the target image.

In a possible implementation, the image may be regarded as a two-dimensional discrete signal. Performing convolution processing on the image includes processes of using a convolution kernel to slide on the image, multiplying a pixel gray-scale value on an image point by a value on the corresponding convolution kernel, then adding the values of all the products to obtain a gray-scale value of the pixel on the image corresponding to a middle pixel of the convolution kernel, and finally sliding through all the images. The convolution operation may be used for image filtering in image processing. Convolution operation processing is performed on the target image according to a set convolution kernel, and the convolution feature of the target image is extracted.

At step S32, classification processing is performed on the convolution feature to determine whether the object having the face executes the set action.

In a possible implementation, the classification processing may include classification processing such as two-category classification, where the two-category classification may include processing input data and then outputting a result indicating to which category the convolution feature belongs in two preset categories. The two categories may be preset as a smoking action and a non-smoking action, and after the convolution feature of the target image is subjected to the two-category classification, the probability of the smoking action and the probability of the non-smoking action of the object having the face in the target image may be obtained.

In a possible implementation, the classification processing may further include multi-category classification processing. After the convolution feature of the target image is subjected to the multi-task classification processing, the probabilities of multiple tasks of the object having the face in the target image are obtained. No limitation is made thereto in the present disclosure.

In the present embodiment, by using the convolution processing and the classification processing, whether the object having the face in the target image executes the set action is determined, and the convolution processing and the classification processing may make a detection result of action detection accurate and high in efficiency during a detection process.

In a possible implementation mode, step S31 includes: performing convolution processing on the target image by means of a convolutional layer of a neural network to extract the convolution feature of the target image; and step S32 includes: performing classification processing on the convolution feature by means of a classification layer of the neural network to determine whether the object having the face executes the set action.

In a possible implementation, the neural network includes mapping from an input to an output, and without the need for an accurate mathematical expression between the input and the output, by learning a large amount of mapping relations between the input and the output and using a known mode to implement training, the output is obtained after subjecting the input to mapping. The neural network is trained using a sample image including a detection action.

In a possible implementation, the neural network includes a convolutional layer and a classification layer, where the convolutional layer is configured to perform the convolution processing on the target image or feature, and the classification layer is configured to perform the classification processing on the feature. No limitation is made to specific implementations of the convolutional layer and the classification layer.

In the present embodiment, by inputting the target image to the trained neural network, and utilizing the strong processing capability of the neural network, an accurate action detection result is obtained.

In a possible implementation, the neural network is obtained by supervised pre-training on the basis of a sample image set including label information, where the sample image set includes a sample image and a noise image obtained by introducing noise on the basis of the sample image.

In a possible implementation, a slight difference may be caused between different detection images due to multiple reasons in the process of obtaining the detection images by the photographing device through photographing. For example, when the photographing device makes a video stream, a difference may be caused between different detection image frames in the video stream due to a slight position change of the photographing device. Because the neural network is considered as function mapping in a higher dimensional space, a large value of a derivative may exist at certain positions in the higher dimensional function, resulting in that a slight pixel-scale difference in the image input to the neural network may also cause large fluctuation in the output feature. In order to improve the operational accuracy of the neural network, a large error output by the neural network caused by the fluctuation (even if it is pixel-scale fluctuation) of the sample image is removed during the training process.

In a possible implementation, the action recognition method further includes: performing at least one of rotation, translation, scale change, or noise addition on the sample image to obtain the noise image.

In a possible implementation, after the sample image is rotated by an extremely small angle, translated by an extremely small distance, scaled up, scaled down, or subjected to other operations, noise is introduced into the sample image to obtain a noise image.

In a possible implementation, both the sample image and the noise image are input into the neural network, a loss of back propagation of the neural network is obtained using an output result obtained according to the sample image, an output result obtained according to the noise image, and label information of the sample image, and the neural network is trained using the obtained loss.

In the present embodiment, by means of the process of obtaining the noise image according to the sample image and training the neural network according to the sample image and the noise image, the stability of features extracted by the trained neural network is strong, the anti-fluctuation performance is good, and an obtained action recognition result is more accurate.

In a possible implementation, the training process for the neural network includes: obtaining respective set action detection results of the sample image and the noise image by means of the neural network, respectively; determining a first loss of the set action detection result of the sample image and the label information thereof, and a second loss of the set action detection result of the noise image and the label information thereof; and adjusting network parameters of the neural network according to the first loss and the second loss.

In a possible implementation, the first loss may include a softmax loss. The softmax loss is used in the multi-category classification process, and multiple outputs are mapped to an interval (0,1) to obtain the classification result. The first loss L_{softmax} is obtained according to the following formula (1):

$${L}_{softmax} = - \frac{1}{N} {\sum }_{i = 1}^{N} log ( {p}_{i} ) \qquad Formula ( 1 )$$

where pᵢ represents the probability of an actual correct category of the sample image output by the neural network, N represents the total number of samples of the sample images (where N is a positive integer), and i represents a sample number (where i is a positive integer and is less than and equal to N).

In a possible implementation, the sample image is input to the neural network to extract a first feature of the sample image; the noise image is input to the neural network to extract a second feature of the noise image; a second loss of the neural network is determined according to the first feature and the second feature. The second loss may include a Euclidean loss.

For example, the sample image may be an image Iₒᵣᵢ having a size of W×H, and a feature vector provided by the corresponding neural network is Fₒᵣᵢ. A certain amount of noise is introduced into Iₒᵣᵢ to obtain the noise image Iₙₒᵢₛₑ. Iₙₒᵢₛₑ is also input into the neural network for performing forward feeding, and a corresponding feature vector provided by the neural network is Fₙₒᵢₛₑ. A difference between the vector Fₒᵣᵢ and the vector Fₙₒᵢₛₑ is recorded as a drift feature ΔF, and the second loss L_{Euclidean} is obtained using the following formula (2):

$${L}_{Euclidean} = {\sum }_{i} {\vert Δ {F}_{i} \vert}^{2} \qquad Formula ( 2 )$$

In a possible implementation, a Loss of the back propagation of the neural network is obtained by using the first loss and the second loss.

The Loss of the back propagation of the neural network is obtained using the following formula (3):

Loss=L_{soft max}+L_{Euclidean} Formula (3)

The neural network is trained using a gradient back propagation method according to the Loss.

In the present embodiment, after obtaining the first loss according to the sample image, obtaining the second loss according to the sample image and the noise image, and obtaining the loss of the back propagation of the neural network according to the first loss and the second loss, the neural network is trained. The anti-fluctuation performance of the trained neural network is good, the stability of extracted features is strong, and the action detection result is accurate.

FIG. 5 is a flowchart illustrating an action recognition method according to embodiments of the present disclosure. As shown in FIG. 5, the action recognition method further includes the following step.

At step S40, warning information is sent when it is recognized that the object having the face executes the set action.

In a possible implementation, when it is detected that the object having the face executes the set action, for example, when it is detected, according to an image of the driver of a vehicle obtained by a road monitoring camera through photographing, that the driver is conducting actions such as smoking, eating, wearing a mask, drinking water/a beverage, making a call, and doing makeup, it indicates that the driver is not concentrated, and there is a safety hazard. Warning information is sent to prompt relevant personnel to intervene.

In a possible implementation, the warning information may include information in multiple forms of representation such as sounds, text, and images. The warning information is divided into different warning levels according to differences between the detected actions. Different pieces of warning information are sent according to different warning levels. No limitation is made thereto in the present disclosure.

In the present embodiment, warning information is sent when it is recognized that the object having the face executes the set action. According to needs, warning information is sent according to the action detection result, so that embodiments of the present disclosure are applicable to different usage needs and different usage environments.

In a possible implementation, step S40 includes: sending the warning information when it is recognized that the object having the face executes the set action and the recognized action satisfies a warning condition.

In a possible implementation, a warning condition is preset. If the recognized action does not satisfy the warning condition, no warning information is sent. If the recognized action is the preset action, the warning information is sent. If the recognized action is not the preset action, the warning information is not sent. Multiple warning conditions may be preset, and different warning conditions correspond to different types or contents of the warning information. The warning conditions and the types or contents of the warning information and the like are adjusted according to needs.

In the present embodiment, the warning information is sent when it is recognized that the object having the face executes the set action and the recognized action satisfies a warning condition. The sent warning information is enabled to be more in line with different usage needs according to the warning condition.

In a possible implementation, the action includes an action duration, and the warning condition includes: recognizing that the action duration exceeds a duration threshold.

In a possible implementation, the action may include an action duration, and if the action duration exceeds the duration threshold, it is considered that the execution of the action distracts more attention from the object executing the action, the action is considered as a dangerous action, and warning information needs to be sent. For example, if the action of smoking of the driver lasts for over 3 seconds, it is considered that the action of smoking is a dangerous action and may affect the action of driving of the driver, and warning information needs to be sent to the driver.

In the present embodiment, a sending condition for the warning information is adjusted according to the action duration and the duration threshold, so that the sending of the warning information is more flexible and applicable to different usage needs.

In a possible implementation, the action includes the number of actions, and the warning condition includes: recognizing that the number of actions exceeds a number threshold.

In a possible implementation, the action includes the number of actions, and when the number of actions exceeds the number threshold, it is considered that the action is frequently conducted by the object executing the action, more attention is distracted, the action is considered as a dangerous action, and warning information needs to be sent. For example, if the number of the actions of smoking of the driver exceeds 5, it is considered that the action of smoking is a dangerous action and may affect the action of driving of the driver, and warning information needs to be sent to the driver.

In the present embodiment, a sending condition for the warning information is adjusted according to the number of actions and the number threshold, so that the sending of the warning information is more flexible and applicable to different usage needs.

In a possible implementation, the action includes the action duration and the number of actions, and the warning condition includes: recognizing that the action duration exceeds the duration threshold and the number of actions exceeds the number threshold.

In a possible implementation, if the action duration exceeds the duration threshold and the number of actions exceeds the number threshold, it is considered that the action is frequently conducted by the object executing the action and the action duration is long, more attention is distracted, the action is considered as a dangerous action, and warning information needs to be sent.

In the present embodiment, a sending condition for the warning information is adjusted according to the number of actions and the number threshold, and the action duration and the duration threshold, so that the sending of the warning information is more flexible and applicable to different usage needs.

In a possible implementation, the sending the warning information when it is recognized that the object having the face executes the set action includes:

determining an action level on the basis of the action recognition result; and

sending level-based warning information corresponding to the action level.

In a possible implementation, action levels are set for different actions. For example, the action of doing makeup has a high danger level, the actions of smoking, eating, and drinking water/a beverage have medium danger levels, and the actions of wearing a mask and making a call have low danger level. Actions having high danger levels are enabled to correspond to advanced warning information, actions having medium danger levels are enabled to correspond to medium-level warning information, and actions having low danger levels are enabled to correspond to low-level warning information. The danger level of the advanced warning information is higher than that of the medium-level warning information, and the danger level of the medium-level warning information is higher than that of the low-level warning information. According to the differences between the actions, warning information of different levels are sent to achieve different warning purposes.

In the present embodiment, by sending different pieces of warning information according to different actions levels, the sending of the warning information is more flexible and applicable to different usage needs.

FIG. 6 is a flowchart illustrating a driver state analysis method according to embodiments of the present disclosure. The driver state analysis method can be executed by electronic devices such as terminal devices or servers, where the terminal devices may be a User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementations, the driver state analysis method may be implemented by means of invoking, by the processor, the computer readable instruction stored in the memory.

As shown in FIG. 6, the driver state analysis method includes the following steps.

At step S100, a detection image of a driver is obtained.

At step S200, using any one of the action recognition methods above, whether the driver executes a set action is recognized.

At step S300, a state of the driver is determined according to the recognized action.

In a possible implementation, a monitoring camera is provided in a vehicle to obtain the detection image of a driver through photographing. The monitoring camera may include various types of cameras such as a visible light camera, an infrared camera, or a near-infrared camera.

In a possible implementation, whether the driver executes a set action is recognized using any one of the action recognition methods above. For example, it can be recognized whether the driver executes the set action such as smoking, eating, wearing a mask, drinking water/a beverage, making a call, and doing makeup.

In a possible implementation, the state of the driver may include a safe state and a dangerous states, or a normal state and a dangerous state, etc. The state of the driver is determined according to the action recognition result of the driver. For example, if the recognized action is the set action such as smoking, eating, wearing a mask, drinking water/a beverage, making a call, and doing makeup, the state of the driver is the dangerous state or an abnormal state.

In a possible implementation, warning information is sent to the driver or a vehicle control center according to the state of the driver, so as to prompt the driver or a manager that the vehicle is possibly in a dangerous driving state.

In the present embodiment, the detection image of the driver is obtained, and using the action recognition method in the embodiments of the present disclosure, whether the driver executes the set action is recognized, and the state of the driver is determined according to the recognized action. The driving safety of the vehicle is improved according to the state of the driver.

In a possible implementation, the driver state analysis method further includes: obtaining vehicle state information; and step S200, including: recognizing, in response to a situation where the vehicle state information satisfies a set triggering condition, and using any one of the action recognition methods above, whether the driver executes the set action.

In a possible implementation mode, state information of the vehicle is obtained, and according to the obtained state information of the vehicle, whether a triggering condition is satisfied is determined. When the state information of the vehicle satisfies the triggering condition, whether the driver executes the set action is recognized using the action recognition method in the embodiments of the present disclosure. A driving action may be recognized by adjusting and setting a triggering condition according to needs of users.

In the present embodiment, vehicle state information is obtained, and if the vehicle state information satisfies the set triggering condition, whether the driver executes the set action is recognized. According to the set triggering condition, the action recognition for drivers is able to conform to different usage needs of users, and the flexibility and application range of the embodiments of the present disclosure are improved.

In a possible implementation, the vehicle state information includes: a vehicle ignition state, and the set triggering condition includes: detecting vehicle ignition.

In a possible implementation, after the vehicle is ignited and travels, if the drives executes the action such as smoking, eating, wearing a mask, drinking water/a beverage, making a call, and doing makeup, the driving safety of the vehicle is affected. The set triggering condition includes detecting vehicle ignition, and by using a monitoring camera in the vehicle to take a monitoring image, the action of the driver after vehicle ignition is recognized, and the driving safety of the vehicle is improved.

In the present embodiment, by recognizing the action of the driver after ignition of the vehicle, the safety of the vehicle in a traveling process is improved.

In a possible implementation, the vehicle state information includes: a vehicle speed, and the set triggering condition includes: detecting that the vehicle speed exceeds a speed threshold.

In a possible implementation, when the vehicle speed exceeds the speed threshold, the attention of the driver needs to be highly concentrated. The set triggering condition includes detecting that the vehicle speed exceeds the speed threshold, and by using a monitoring camera in the vehicle to take a monitoring image, the action of the driver after the vehicle speed exceeds the speed threshold is recognized, and the driving safety of the vehicle is improved.

In the present embodiment, by recognizing the action of the driver after the vehicle speed exceeds the speed threshold, the safety of the vehicle in a traveling process is improved.

In a possible implementation, the driver state analysis method further includes:

transferring the state of the driver to a set contact or a designated server platform.

In a possible implementation, the state of the driver is transferred to the contact, for example, transferring to a relative of the driver, or a manager, so that the set contact of the driver obtains the state of the driver and monitors the driving state of the vehicle. The state of the driver may also be transferred to the designated server platform, for example, transferring to a manager server platform of the vehicle, so that the manager of the vehicle obtains the state of the driver and monitors the driving state of the vehicle.

In the present embodiment, by transferring the state of the driver to the set contact or the designated server platform, the set contact or the manager of the designated server platform is able to monitor the driving state of the vehicle.

In a possible implementation, the driver state analysis method further includes:

storing or sending the detection image including an action recognition result of the driver, or

storing or sending the detection image including the action recognition result of the driver and video clips of a predetermined number of frames before and after the image.

In a possible implementation, the detection image including the action recognition result of the driver, or the detection image including the action recognition result of the driver and video clips of a predetermined number of frames before and after the image is stored or sent. A storage device is used for implementing storing or sending to the set memory for storage, so that the detection image or video clips can be stored in a long term.

In the present embodiment, by storing or sending the detection image including the action recognition result of the driver or the video clips, the detection image or the video clips can be stored in a long term.

### Application Example

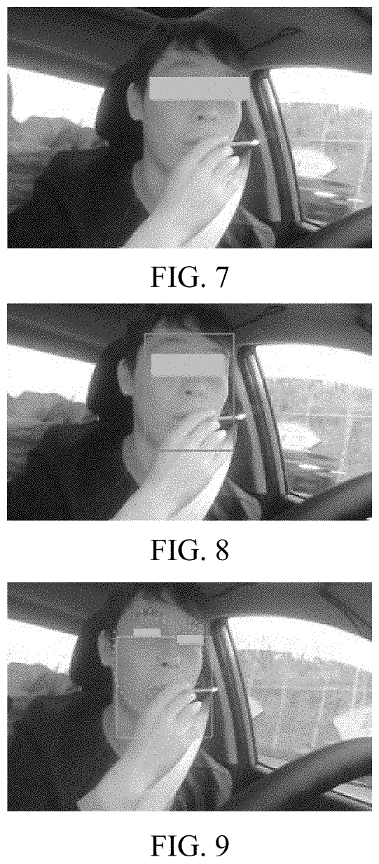

FIG. 7 is a detection image in an action recognition method according to embodiments of the present disclosure. As shown in FIG. 7, the detection image is an image of the driver of a vehicle obtained by a road monitoring camera through photographing. The driver in the detection image is smoking.

FIG. 8 is a schematic diagram illustrating a face detection result in an action recognition method according to embodiments of the present disclosure. By performing the face detection on the detection image using the action recognition method in the embodiments of the present disclosure, the position of the face in the detection image is obtained. As shown in FIG. 8, the region where the face of the driver is located is determined by using a face detection bounding box in FIG. 8.

FIG. 9 is a schematic diagram illustrating determining a target image in an action recognition method according to embodiments of the present disclosure. The face key points is further detected, and the mouth on the face is determined according to the face key points. Taking the mouth as a center, and a length twice the distance from the mouth to the place between the eyebrows as a capture length, the target image of the mouth is captured. As shown in FIG. 9, the captured target image of the mouth includes a partial region outside the face and below the mouth. Moreover, the partial region outside the face and below the mouth includes a hand conducting smoking and smoke.

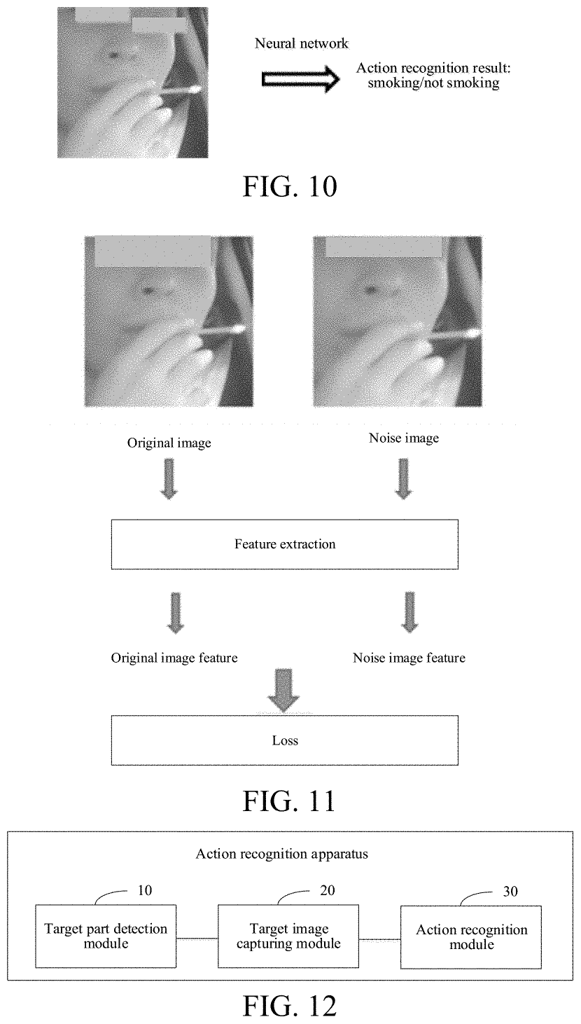

FIG. 10 is a schematic diagram illustrating performing action recognition in an action recognition method according to embodiments of the present disclosure. As shown in FIG. 10, after the captured target image in FIG. 9 is input to the neural network, the action recognition result indicating whether the driver is smoking is obtained.

FIG. 11 is a schematic diagram illustrating introducing a noise image to train a neural network in an action recognition method according to embodiments of the present disclosure. As shown in FIG. 7, the noise image at the upper right side is obtained after noise is introduced into the target image at the upper left side. Both the target image and the noise image are input to the neural network for feature extraction, so as to respectively obtain a target image feature and a noise image feature. According to the target image feature and the noise image feature, the loss is obtained, and parameters of the neural network are adjusted according to the loss.

It can be understood that the foregoing various method embodiments mentioned in the present disclosure may be combined with each other to form a combined embodiment without departing from the principle logic. Details are not described in the present disclosure again due to space limitation.

In addition, the present disclosure further provides an action recognition apparatus, a driver state analysis apparatus, an electronic device, a computer readable storage medium, and a program, which can all be configured to implement any one of the action recognition methods and the driver state analysis methods provided in the present disclosure. For the corresponding technical solutions and descriptions, please refer to the corresponding contents in the method parts. Details are not described herein again.

FIG. 12 is a block diagram illustrating an action recognition apparatus according to embodiments of the present disclosure. As shown in FIG. 12, the action recognition apparatus includes:

a target part detection module 10, configured to detect a target part on a face in a detection image;

a target image capturing module 20, configured to capture a target image corresponding to the target part from the detection image according to the detection result for the target part; and

an action recognition module 30, configured to recognize, according to the target image, whether the object having the face executes a set action.

In the present embodiment, a target part on a face is recognized in a detection image, a target image corresponding to the target part is captured from the detection image according to the detection result for the target part, and according to the target image, whether the object having the face executes a set action is recognized. The target images captured according to the detection result for the target part are applicable to faces of different sizes in different detection images, and are also applicable to faces of different types. The embodiments of the present disclosure have a wide application range. Not only the target images may include sufficient information for analysis, but also the problems of low system processing efficiency caused by oversized captured target images and excessive useless information are reduced

In a possible implementation, the target part detection module 10 includes: a face detection sub-module, configured to detect the face in the detection image; a key point detection sub-module, configured to detect face key points according to the face detection result; and a target part detection sub-module, configured to determine the target part on the face in the detection image according to the detection result for the face key points.

In the present embodiment, a face is detected in the detection image, face key points are then detected, and a target part is determined according to the face key points. The target part determined according to the face key points is more accurate.

In a possible implementation, the target part may include one or any combination of the following parts: mouth, ear, nose, eye, and eyebrow. The target part on the face is determined according to needs. The target part on the face may include one or more parts, and is detected by means of the face detection technology.

In a possible implementation, the set action may include one or any combination of the following actions: smoking, eating, wearing a mask, drinking water/a beverage, making a call, and doing makeup. When the object having the face executes the set action, the target may simultaneously conduct an action such as driving, walking, and riding, and the set action may distract the attention of the object having the face, causing safety hazards. According to the recognition result of the set action, applications such as safety analysis are carried out on the object having the face.

In a possible implementation, the apparatus further includes: a detection image acquisition module, configured to acquire the detection image by means of a camera, the camera including at least one of: a visible light camera, an infrared camera, or a near-infrared camera. The visible light camera is configured to acquire a visible light image, the infrared camera is configured to acquire an infrared image, and the near-infrared camera is configured to acquire a near-infrared image.

In a possible implementation, the target part includes the mouth, the face key points include mouth key points, and the target part detection sub-module is configured to: determine the mouth on the face in the detection image according to a detection result for the mouth key points.

In a possible implementation, the face key points may include mouth key points, ear key points, nose key points, eye key points, eyebrow key points, face outer contour key points, and the like. The mouth key points may include one or more key points on an upper lip contour line and a lower lip contour line. The mouth on the face in the detection is determined according to the mouth key points.

In a possible implementation, the target part includes the mouth, the face key points include the mouth key points and an eyebrow key points, and the target part detection sub-module 20 includes: a distance determination sub-module, configured to determine a distance from the mouth to the place between the eyebrows on the face in the detection image according to the detection result for the mouth key points and the eyebrow key points; and a mouth image capturing sub-module, configured to capture the target image corresponding to the mouth from the detection image according to the mouth key points and the distance.

In the present embodiment, the target image of the mouth captured according to the distance from the mouth to the place between the eyebrows on the face is more in line with the features of the face, and may include a region outside the face and below the mouth, making the result of action detection taking the mouth as the target part become more accurate.

In a possible implementation, the action recognition module 30 includes: a feature extraction sub-module, configured to perform convolution processing on the target image to extract a convolution feature of the target image; and a classification processing sub-module, configured to perform classification processing on the convolution feature to determine whether the object having the face executes the set action.

In the present embodiment, by using the convolution processing and the classification processing, whether the object having the face in the target image executes the set action is determined, and the convolution processing and the classification processing may make the detection result of action detection accurate and high in efficiency during a detection process.

In a possible implementation, the feature extraction sub-module is configured to: perform convolution processing on the target image by means of a convolutional layer of a neural network to extract the convolution feature of the target image; and the classification processing sub-module is configured to: perform classification processing on the convolution feature by means of a classification layer of the neural network to determine whether the object having the face executes the set action.

In the present embodiment, by inputting the target image to the trained neural network, and utilizing the strong processing capability of the neural network, an accurate action detection result is obtained.

In a possible implementation, the neural network is obtained by supervised pre-training on the basis of a sample image set including label information, where the sample image set includes a sample image and a noise image obtained by introducing noise on the basis of the sample image.

In the present embodiment, by means of the process of obtaining the noise image according to the sample image and training the neural network according to the sample image and the noise image, the stability of features extracted by the trained neural network is strong, the anti-fluctuation performance is good, and an obtained action recognition result is more accurate.

In a possible implementation, the neural network includes a training module, which includes: a detection result obtaining sub-module, configured to obtain respective set action detection results of the sample image and the noise image by means of the neural network, respectively; a loss determination sub-module, configured to determine a first loss of the set action detection result of the sample image and the label information thereof, and a second loss of the set action detection result of the noise image and the label information thereof; and a parameter adjustment sub-module, configured to adjust network parameters of the neural network according to the first loss and the second loss.

In the present embodiment, after obtaining the first loss according to the sample image, obtaining the second loss according to the sample image and the noise image, and obtaining the loss of the back propagation of the neural network according to the first loss and the second loss, the neural network is trained. The anti-fluctuation performance of the trained neural network is good, the stability of extracted features is strong, and the action detection result is accurate.

In a possible implementation, the apparatus further includes: a noise image obtaining module, configured to perform at least one of rotation, translation, scale change, or noise addition on the sample image to obtain the noise image.

In a possible implementation, after the sample image is rotated by an extremely small angle, translated by an extremely small distance, scaled up, scaled down, or subjected to other operations, noise is introduced into the sample image to obtain a noise image.

In a possible implementation, the apparatus further includes: a warning information sending module, configured to send warning information when it is recognized that the object having the face executes the set action.

In the present embodiment, warning information is sent when it is recognized that the object having the face executes the set action. According to needs, warning information is sent according to the action detection result, so that embodiments of the present disclosure are applicable to different usage needs and different usage environments.

In a possible implementation, the warning information sending module includes:

a first warning information sending sub-module, configured to send the warning information when it is recognized that the object having the face executes the set action and the recognized action satisfies a warning condition.

In the present embodiment, the warning information is sent when it is recognized that the object having the face executes the set action and the recognized action satisfies a warning condition. The sent warning information is enabled to be more in line with different usage needs according to the warning condition.

In a possible implementation, the action includes an action duration, and the warning condition includes: recognizing that the action duration exceeds a duration threshold.

In the present embodiment, a sending condition for the warning information is adjusted according to the action duration and the duration threshold, so that the sending of the warning information is more flexible and applicable to different usage needs.

In a possible implementation, the action includes the number of actions, and the warning condition includes: recognizing that the number of actions exceeds a number threshold.

In the present embodiment, a sending condition for the warning information is adjusted according to the number of actions and the number threshold, so that the sending of the warning information is more flexible and applicable to different usage needs.

In a possible implementation, the action includes the action duration and the number of actions, and the warning condition includes: recognizing that the action duration exceeds the duration threshold and the number of actions exceeds the number threshold.

In the present embodiment, a sending condition for the warning information is adjusted according to the number of actions and the number threshold, and the action duration and the duration threshold, so that the sending of the warning information is more flexible and applicable to different usage needs.

In a possible implementation, the warning information sending module includes: an action level determination sub-module, configured to determine an action level on the basis of the action recognition result; and a level-based warning information sending sub-module, configured to send level-based warning information corresponding to the action level.

In the present embodiment, by sending different pieces of warning information according to different actions levels, the sending of the warning information is more flexible and applicable to different usage needs.

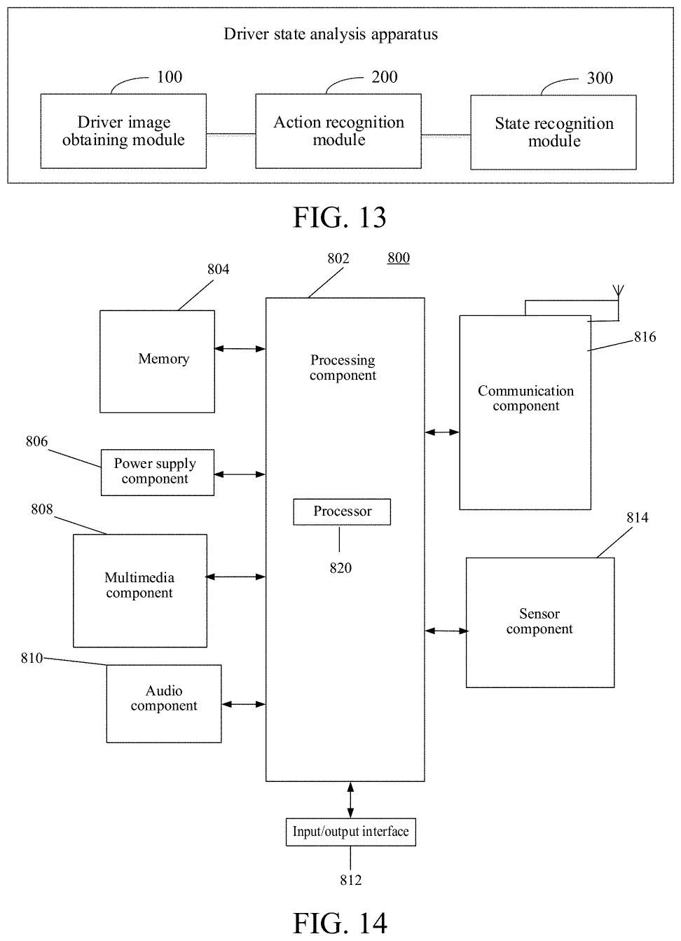

FIG. 13 is a block diagram illustrating a driver state analysis apparatus according to embodiments of the present disclosure. As shown in FIG. 13, the apparatus includes:

a driver image obtaining module 100, configured to obtain a detection image of a driver;

an action recognition module 200, configured to recognize, using any one of the action recognition apparatuses above, whether the driver executes a set action; and

a state recognition module 300, configured to determine a state of the driver according to the recognized action.

In the present embodiment, the detection image of the driver is obtained, and using the action recognition apparatus in the embodiments of the present disclosure, whether the driver executes the set action is recognized, and the state of the driver is determined according to the recognized action. The driving safety of the vehicle is improved according to the state of the driver.

In a possible implementation, the apparatus further includes: a vehicle state obtaining module, configured to obtain vehicle state information; and

the action recognition module includes:

a condition response sub-module, configured to recognize, in response to a situation where the vehicle state information satisfies a set triggering condition, and using the action recognition apparatus according to any one of claims 25 to 42, whether the driver executes the set action.

In the present embodiment, vehicle state information is obtained, and if the vehicle state information satisfies the set triggering condition, whether the driver executes the set action is recognized. According to the set triggering condition, the action recognition for drivers is able to conform to different usage needs of users, and the flexibility and application range of the embodiments of the present disclosure are improved.

In a possible implementation, the vehicle state information includes: a vehicle ignition state, and the set triggering condition includes: detecting vehicle ignition.

In the present embodiment, by recognizing the action of the driver after ignition of the vehicle, the safety of the vehicle in a traveling process is improved.

In a possible implementation, the vehicle state information includes: a vehicle speed, and the set triggering condition includes: detecting that the vehicle speed exceeds a speed threshold.

In the present embodiment, by recognizing the action of the driver after the vehicle speed exceeds the speed threshold, the safety of the vehicle in a traveling process is improved.

In a possible implementation, the apparatus further includes: a state transfer module, configured to transfer the state of the driver to a set contact or a designated server platform.

In the present embodiment, by transferring the state of the driver to the set contact or the designated server platform, the set contact or the manager of the designated server platform is able to monitor the driving state of the vehicle.

In a possible implementation, the apparatus further includes: a storing and sending module, configured to store or send the detection image including an action recognition result of the driver, or store or send the detection image including the action recognition result of the driver and video clips of a predetermined number of frames before and after the image.

In the present embodiment, by storing or sending the detection image including the action recognition result of the driver or the video clips, the detection image or the video clips can be stored in a long term.

In some embodiments, the functions provided by or the modules included in the apparatuses provided by the embodiments of the present disclosure may be used to implement the methods described in the foregoing method embodiments. For specific implementations, reference may be made to the description in the method embodiments above. For the purpose of brevity, details are not described herein again.

The embodiments of the present disclosure further provide an electronic device, including: a processor; and a memory configured to store processor-executable instructions, where the processor executes the action recognition method and/or the driver state analysis method by directly or indirectly calling the executable instructions.

Embodiments of the present disclosure further provide a computer readable storage medium, having computer program instructions thereon, where when the computer program instructions are executed by a processor, the action recognition method and/or the driver state analysis method above are implemented. The computer-readable storage medium may be a nonvolatile computer-readable storage medium or a volatile computer-readable storage medium.

Embodiments of the present disclosure further provide a computer program, including a computer readable code, where when the computer readable code runs in an electronic device, a processor in the electronic device executes the action recognition method and/or the driver state analysis method.

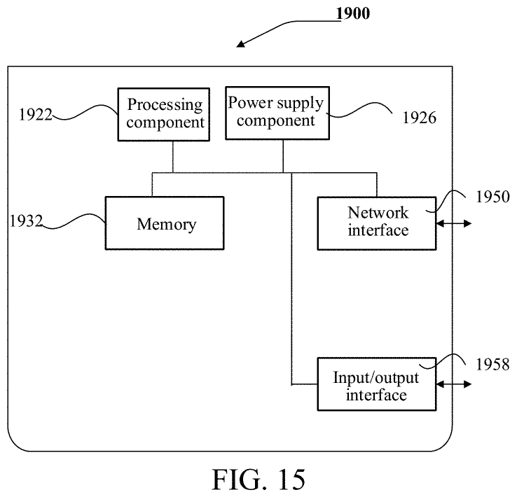

FIG. 14 is a block diagram illustrating an action recognition apparatus 800 according to exemplary embodiments. For example, the apparatus 800 may be terminals such as a mobile phone, a computer, a digital broadcast terminal, a message transceiving device, a game console, a tablet device, a medical device, exercise equipment, and a personal digital assistant.

With reference to FIG. 14, the apparatus 800 may include one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the apparatus 800, such as operations associated with display, phone calls, data communications, camera operations, and recording operations. The processing component 802 may include one or more processors 820 to execute instructions to implement all or some of the steps of the methods above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the apparatus 800. Examples of the data include instructions for any application or method operated on the apparatus 800, contact data, contact list data, messages, pictures, videos, and the like. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power supply component 806 provides power for various components of the apparatus 800. The power supply component 806 may include a power management system, one or more power supplies, and other components associated with power generation, management, and distribution for the apparatus 800.

The multimedia component 808 includes a screen between the apparatus 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the apparatus 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the apparatus 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, which may be a keyboard, a click wheel, a button, etc. The button may include, but is not limited to, a home button, a volume button, a start button, and a lock button.

The sensor assembly 814 includes one or more sensors for providing state assessment in various aspects for the apparatus 800. For example, the sensor component 814 may detect an on/off state of the apparatus 800, and relative positioning of components, which are for example the display and keypad of the apparatus 800, and the sensor assembly 814 may further detect a position change of the apparatus 800 or a component of the apparatus 800, the presence or absence of contact of the user with the apparatus 800, the orientation or acceleration/deceleration of the apparatus 800, and a temperature change of the apparatus 800.

The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the apparatus 800 and other devices. The apparatus 800 may access a wireless network based on a communication standard, such as WiFi, 2G, or 3G, or a combination thereof. In one exemplary embodiment, the communication component 816 receives a broadcast signal or broadcast-related information from an external broadcast management system by means of a broadcast channel. In one exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In exemplary embodiments, the apparatus 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In exemplary embodiments, a non-volatile computer readable storage medium is further provided, for example, a memory 804 including computer program instructions, which may be executed by the processor 820 of the apparatus 800 to implement the method above.

FIG. 15 is a block diagram illustrating an action recognition apparatus 1900 according to exemplary embodiments. For example, the apparatus 1900 may be provided as a server. With reference to FIG. 15, the apparatus 1900 includes a processing component 1922 which further includes one or more processors, and a memory resource represented by a memory 1932 and configured to store instructions executable by the processing component 1922, for example, an application program. The application program stored in the memory 1932 may include one or more modules, each of which corresponds to a set of instructions. Further, the processing component 1922 may be configured to execute instructions so as to execute the above methods.

The apparatus 1900 may further include a power supply component 1926 configured to execute power management of the apparatus 1900, a wired or wireless network interface 1950 configured to connect the apparatus 1900 to the network, and an I/O interface 1958. The apparatus 1900 may be operated based on an operating system stored in the memory 1932, such as Windows Server™, Mac OS X™, Unix™, Linux™, FreeBSD™ or the like.

In an exemplary embodiment, a non-volatile computer-readable storage medium is further provided, for example, a memory 1932 including computer program instructions, which can be executed by the processor 1922 of the apparatus 1900 to implement the method above.

The present disclosure may be a system, a method, and/or a computer program product. The computer program product may include a computer readable storage medium having computer readable program instructions thereon for enabling a processor to implement aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination thereof. More specific examples (a non-exhaustive list) of the computer readable storage medium include: a portable computer diskette, a hard disk, a Random Access Memory (RAM), an ROM, an EPROM (or a flash memory), a SRAM, a portable Compact Disk Read-Only Memory (CD-ROM), a Digital Versatile Disc (DVD), a memory stick, a floppy disk, a mechanically encoded device such as punch-cards or raised structure in a groove having instructions stored thereon, and any suitable combination thereof. A computer readable storage medium, as used herein, is not to be construed as being transitory signals per se, such as radio waves or other freely propagating electromagnetic waves, electromagnetic waves propagating by means of a waveguide or other transmission media (e. g., light pulses passing through a fiber-optic cable), or electrical signals transmitted by means of a wire.

Computer-readable program instructions described herein may be downloaded to respective computing/processing devices from the computer readable storage medium or to an external computer or external storage device by means of a network, for example, the Internet, a Local Area Network (LAN), a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. Computer readable program instructions may be executed completely on a user computer, executed partially on the user computer, executed as an independent software package, executed partially on the user computer and partially on a remote computer, or executed completely on the remote computer or server. In a scenario involving the remote computer, the remote computer may be connected to the user computer by means of any type of network, including a LAN or a Wide Area Network (WAN), or the connection may be made to an external computer (for example, connecting by using an Internet service provider by means of the Internet). In some embodiments, electronic circuitry including, for example, programmable logic circuitry, the FGPAs, or Programmable Logic Arrays (PLAs) may execute the computer readable program instructions by utilizing state information of the computer readable program instructions to personalize the electronic circuitry, so as to implement the aspects of the present disclosure.

The aspects of the present disclosure are described herein with reference to flowcharts and/or block diagrams of methods, apparatuses (systems), and computer program products according to the embodiments of the present disclosure. It should be understood that each block of the flowcharts and/or block diagrams, and combinations of the blocks in the flowcharts and/or block diagrams may be implemented by the computer readable program instructions.

These computer readable program instructions may be provided to a processor of a general-purpose computer, special-purpose computer, or other programmable data processing apparatus to produce a machine, such that the instructions, which execute by means of the processor of the computer or other programmable data processing apparatuses, create means for executing the functions/actions specified in one or more blocks of the flowcharts and/or block diagrams. These computer readable program instructions may also be stored in the computer readable storage medium, the instructions enable the computer, the programmable data processing apparatus, and/or other devices to function in a particular manner, so that the computer readable medium having instructions stored therein includes an article of manufacture including instructions which implement the aspects of the functions/actions specified in one or more blocks of the flowcharts and/or block diagrams.

The computer readable program instructions may also be loaded onto a computer, other programmable data processing apparatuses, or other devices to cause a series of operational steps to be performed on the computer, other programmable apparatuses or other devices to produce a computer implemented process, so that the instructions which execute on the computer, other programmable apparatuses or other devices implement the functions/actions specified in one or more blocks of the flowcharts and/or block diagrams.

The flowcharts and block diagrams in the accompanying drawings illustrate the architecture, functionality and operations of possible implementations of systems, methods, and computer program products according to multiple embodiments of the present disclosure. In this regard, each block in the flowchart or block diagram may represent a module, program segment, or portion of instruction, which includes one or more executable instructions for executing the specified logical function. In some alternative implementations, the functions noted in the block may also occur out of the order noted in the accompanying drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts, may be implemented by special purpose hardware-based systems that perform the specified functions or actions or implemented by combinations of special purpose hardware and computer instructions.

Without violating logics, different embodiments of the present application can be combined with one another; different embodiments emphasize different aspects; for parts which are not described in details, reference may be made to recitations of other embodiments.

The descriptions of the embodiments of the present disclosure have been presented for purposes of illustration, but are not intended to be exhaustive or limited to the embodiments disclosed. Many modifications and variations will be apparent to persons of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

What is claimed is:

1. An action recognition method, comprising:
detecting a target part on a face in a detection image;
capturing a target image corresponding to the target part from the detection image according to a detection result for the target part; and
recognizing, according to the target image, whether an object having the face executes a set action.

2. The method according to claim 1, wherein detecting the target part on the face in the detection image comprises:
detecting the face in the detection image;
detecting face key points according to a face detection result; and
determining the target part on the face in the detection image according to a detection result for the face key points.

3. The method according to claim 1, wherein the target part comprises one or any combination of the following parts: mouth, ear, nose, eye, and eyebrow, and
wherein the set action comprises one or any combination of the following actions: smoking, eating, wearing a mask, drinking water/a beverage, making a call, and doing makeup.

4. The method according to claim 1, wherein before detecting the target part on the face in the detection image, the method further comprises:
acquiring the detection image by means of a camera, the camera comprising at least one of: a visible light camera, an infrared camera, or a near-infrared camera.

5. The method according to claim 2, wherein the target part comprises a mouth, the face key points comprise mouth key points, and determining the target part on the face in the detection image according to the detection result for the face key points comprises:
determining the mouth on the face in the detection image according to a detection result for the mouth key points.

6. The method according to claim 3, wherein the target part comprises the mouth, the face key points comprise the mouth key points and eyebrow key points, and capturing the target image corresponding to the target part from the detection image according to the detection result for the target part comprises:
determining a distance from the mouth to a place between the eyebrows on the face in the detection image according to the detection result for the mouth key points and the eyebrow key points; and
capturing the target image corresponding to the mouth from the detection image according to the mouth key points and the distance.

7. The method according to claim 1, wherein recognizing, according to the target image, whether the object having the face executes the set action comprises:
performing convolution processing on the target image to extract a convolution feature of the target image; and
performing classification processing on the convolution feature to determine whether the object having the face executes the set action.

8. The method according to claim 7, wherein performing convolution processing on the target image to extract the convolution feature of the target image comprises:
performing convolution processing on the target image by means of a convolutional layer of a neural network to extract the convolution feature of the target image; and
performing classification processing on the convolution feature to determine whether the object having the face executes the set action comprises:
performing classification processing on the convolution feature by means of a classification layer of the neural network to determine whether the object having the face executes the set action.

9. The method according to claim 8, wherein the neural network is obtained by supervised pre-training on the basis of a sample image set comprising label information, wherein the sample image set comprises a sample image and a noise image obtained by introducing noise on the basis of the sample image.

10. The method according to claim 9, wherein a training process for the neural network comprises:
obtaining respective set action detection results of the sample image and the noise image by means of the neural network, respectively;
determining a first loss of the set action detection result of the sample image and the label information thereof, and a second loss of the set action detection result of the noise image and the label information thereof, and
adjusting network parameters of the neural network according to the first loss and the second loss.

11. The method according to claim 9, further comprising:
performing at least one of rotation, translation, scale change, or noise addition on the sample image to obtain the noise image.

12. The method according to claim 1, further comprising:
sending warning information when it is recognized that the object having the face executes the set action.

13. The method according to claim 12, wherein sending the warning information when it is recognized that the object having the face executes the set action comprises:
sending the warning information when it is recognized that the object having the face executes the set action and the recognized action satisfies a warning condition,
wherein the action comprises at least one of an action duration and a number of actions,
wherein the warning condition comprises at least one of:
recognizing that the action duration exceeds a duration threshold;
recognizing that the number of actions exceeds a number threshold;
recognizing that the action duration exceeds the duration threshold and the number of actions exceeds the number threshold.

14. The method according to claim 13, wherein sending the warning information when it is recognized that the object having the face executes the set action comprises:
determining an action level on the basis of the action recognition result; and
sending level-based warning information corresponding to the action level.

15. The method according to claim 1, wherein the image is an obtained detection image of a driver,
wherein the method further comprises determining a state of the driver according to the recognized action.

16. The method according to claim 15, further comprising:
obtaining vehicle state information; and
recognizing, in response to a situation where the vehicle state information satisfies a set triggering condition, whether the driver executes the set action.

17. The method according to claim 16, wherein the vehicle state information comprises at least one of a vehicle ignition state and a vehicle speed,
wherein the set triggering condition comprises at least one of:
detecting vehicle ignition;
detecting that the vehicle speed exceeds a speed threshold.

18. The method according to claim 15, further comprising at least one of:
transferring the state of the driver to a set contact or a designated server platform;
storing or sending the detection image comprising an action recognition result of the driver;
storing or sending the detection image comprising the action recognition result of the driver and video clips of a predetermined number of frames before and after the image.

19. An electronic device, comprising:
a processor; and
a memory, configured to store processor-executable instructions;
wherein the processor is configured to: execute an action recognition method, the method comprising:
detecting a target part on a face in a detection image;
capturing a target image corresponding to the target part from the detection image according to a detection result for the target part; and
recognizing, according to the target image, whether an object having the face executes a set action.

20. A computer readable storage medium, having computer program instructions stored thereon, wherein when the computer program instructions are executed by a processor, an action recognition method is implemented, the method comprising:
detecting a target part on a face in a detection image;
capturing a target image corresponding to the target part from the detection image according to a detection result for the target part; and
recognizing, according to the target image, whether an object having the face executes a set action.
